(19) United States
(12) Patent Application Publication
(10) Pub. No.: US 2026/0188326 A1
(43) Pub. Date: Jul. 2, 2026

(54) SYSTEMS AND COMPUTER-IMPLEMENTED METHODS FOR VOICE ANALYSIS AND AUTHENTICATION OF A USER BASED ON CONFIDENCE METRICS

(71) Applicant: CloneOps.ai, LLC, Fort Lauderdale, FL (US)

(72) Inventors: David Ernest Bell, JR., Fort Lauderdale, FL (US); Roger Boza, Miami, FL (US); Cesar Reyes, Miami, FL (US); Saša Jovicic, Parkland, FL (US); Nagarajan Prabakar, Miami, FL (US); Juan Ernesto Hernandez Romero, Miami, FL (US)

(21) Appl. No.: 19/432,481

(22) Filed: Dec. 24, 2025

Related U.S. Application Data
(60) Provisional application No. 63/738,965, filed on Dec. 26, 2024.

(51) Int. Cl. G10L 17/24; G06F 21/32; G10L 15/08; G10L 15/16; G10L 17/18

(52) U.S. Cl. CPC G10L 17/24; G06F 21/32; G10L 15/16; G10L 17/18; G10L 2015/088

(57) ABSTRACT

Systems and computer-implemented methods for voice analysis and authentication of a user based on confidence metrics are disclosed. According to an aspect, a system includes a voice identification module configured to receive voice data associated with a user. The voice identification module is also configured to receive user input that indicates an identifier of the user, and to analyze the voice data of the user to generate at least one confidence metric indicative of a consistency of the voice data of the user with stored voice data of an identified user. The voice identification module determines whether the at least confidence metric meets one or more criterion for authenticating a user's voice, and to implement an action associated with authenticating the user associated with the received voice data and the identifier of the user in response to a determination that the at least confidence metric meets one or more criterion.

### CROSS-REFERENCE TO RELATED APPLICATION

This application claims priority to U.S. Provisional Patent Application No. 63/738,965, filed Dec. 26, 2024, and titled “Voice Authentication System and Method”, the content of which is incorporated herein by reference in its entirety.

### BACKGROUND

Voice authentication, also referred to as voice biometrics, is a method of identity verification that leverages the unique characteristics of an individual's voice. Human voices exhibit distinctive features such as pitch, tone, cadence, accent, pronunciation patterns, and vocal tract resonance. These features arise from a combination of physiological attributes, including vocal cord structure and mouth shape, as well as behavioral characteristics such as speaking style and rhythm. Because these traits are difficult to precisely replicate, voice-based authentication has emerged as a viable biometric modality for verifying identity in both remote and in-person interactions.

Voice authentication systems typically generate a digital representation of a speaker's voice, often referred to as a voiceprint, which can be stored and later compared against newly captured audio samples. These systems rely on signal processing techniques and pattern recognition methods to extract distinguishing features from voice signals. Commonly analyzed parameters include frequency content, amplitude variation, temporal dynamics, and spectral distributions. Compared to knowledge-based authentication methods such as passwords or personal identification numbers (PINs), voice-based systems reduce reliance on memorized secrets and provide a more natural user experience.

Voice-based authentication offers several practical advantages, particularly in environments where hands-free or remote verification is desirable. Because microphones are already integrated into telecommunication systems, mobile devices, and computing platforms, voice authentication can be deployed without requiring specialized hardware. As a result, voice-based systems are well suited for applications such as call centers, virtual agents, telephony-based services, and automated customer interactions.

There is a continuing need for improved systems and techniques for voice-based authentication.

### SUMMARY OF THE DISCLOSURE

The presently disclosed subject matter includes systems and computer-implemented methods for voice analysis and authentication of a user based on confidence metrics. According to an aspect, a system includes a voice identification module configured to receive voice data associated with a user. The voice identification module is also configured to receive user input that indicates an identifier of the user. Further, the voice identification module is configured to analyze the voice data of the user to generate at least one confidence metric indicative of a consistency of the voice data of the user with stored voice data of an identified user. The voice identification module is also configured to determine whether the at least confidence metric meets one or more criterion for authenticating a user's voice. Further, the voice identification module is configured to implement an action associated with authenticating the user associated with the received voice data and the identifier of the user in response to a determination that the at least confidence metric meets one or more criterion for authenticating a user's voice.

In other aspects, a system includes a voice identification module configured to initiate a communication session with a user via the user's computing device. The voice identification module is also configured to receive, from the user's computing device, an identifier of the user. Further, the voice identification module is configured to determine that the identifier of the user is verified. The voice identification module is also configured to send a passphrase to the user's computing device for prompting the user to speak the passphrase in response to the determination that the identifier of the user is verified. Further, the voice identification module is configured to receive, from the user's computing device, voice data corresponding to the user speaking the passphrase for input. The voice identification module is also configured to analyze the spoken passphrase to determine that the spoken passphrase matches the user's voice and that the spoken passphrase in the received voice data matches the sent passphrase. Further, the voice identification module is configured to authenticate the user based on the determination that the spoken passphrase in the received voice data matches the passphrase, the determination that the spoken passphrase matches the user's voice, and that the spoken passphrase is received within a predetermined time period subsequent to sending the passphrase to the user's computing device.

In embodiments described herein, systems and computer-implemented methods are provided for voice-based identification, authentication, fraud detection, and risk signaling using biometric voice characteristics, including but not limited to dynamic passphrases, speaker embeddings, autoencoder-based analysis, and hybrid confidence scoring techniques.

### BRIEF DESCRIPTION OF DRAWINGS

Having thus described the presently disclosed subject matter in general terms, reference will now be made to the accompanying Drawings, which are not necessarily drawn to scale, and wherein:

FIG. 1 is a block of system for authenticating a user based on analysis of the user's voice in accordance with embodiments of the present disclosure;

FIG. 2 is a flow diagram of a method for authenticating a user based on analysis of the user's voice in accordance with embodiments of the present disclosure;

FIG. 3 is a flow diagram of a method for authenticating a user based on analysis of the user's voice in accordance with embodiments of the present disclosure;

FIG. 4 is a diagram depicting system architecture and operational flow for systems disclosed herein that implement voice-based identification with optional dual-factor authentication in accordance with embodiments of the present disclosure;

FIG. 5 is a diagram depicting a voice authentication pipeline using Convolutional Autoencoders in accordance with embodiments of the present disclosure; and

FIG. 6 is a diagram depicting spectrogram reconstruction error for voice authentication in accordance with embodiments of the present disclosure.

### DETAILED DESCRIPTION OF THE DISCLOSURE

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a GUI that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

Artificial intelligence (AI) and machine learning (ML) can be utilized to improve the accuracy and robustness of voice authentication technologies. In examples, systems can employ neural networks capable of learning complex, high-dimensional representations of speech data. These models can adapt to natural variations in a user's voice over time due to factors such as aging, illness, emotional state, or environmental conditions. In addition, AI-driven approaches enable real-time analysis and anomaly detection, improving the system's ability to identify unauthorized or suspicious access attempts.

Voice-based authentication can offer several practical advantages, particularly in environments where hands-free or remote verification is desirable. Because microphones are already integrated into telecommunication systems, mobile devices, and computing platforms, voice authentication can be deployed without requiring specialized hardware. As a result, voice-based systems are well suited for applications such as call centers, virtual agents, telephony-based services, and automated customer interactions.

Voice authentication systems face a number of technical and security challenges. Voice signals are inherently variable and can be affected by background noise, transmission quality, and changes in speaking conditions. Additionally, the rise of synthetic speech generation technologies, including voice cloning and deepfake audio, has introduced new attack vectors capable of imitating a target speaker with increasing realism. These developments highlight the need for authentication systems that incorporate liveness detection, contextual verification, and multi-layered analysis rather than relying solely on static voice comparisons.

Privacy and data protection considerations also play a critical role in the deployment of voice biometric systems. Voice data constitutes sensitive biometric information, and improper handling or storage of such data can result in significant security and regulatory risks. Accordingly, voice-based authentication technologies must incorporate safeguards such as secure storage, encryption, access controls, and compliance with applicable data protection regulations.

As adoption of voice-based systems continues to grow across industries including finance, healthcare, telecommunications, and logistics, there is an increasing demand for solutions that balance security, usability, scalability, and fraud resistance. Systems and computer-implemented methods described herein address these challenges by providing a voice-based identification and authentication framework designed to operate in real-world, high-risk environments while remaining adaptable to evolving threats and technological advancements.

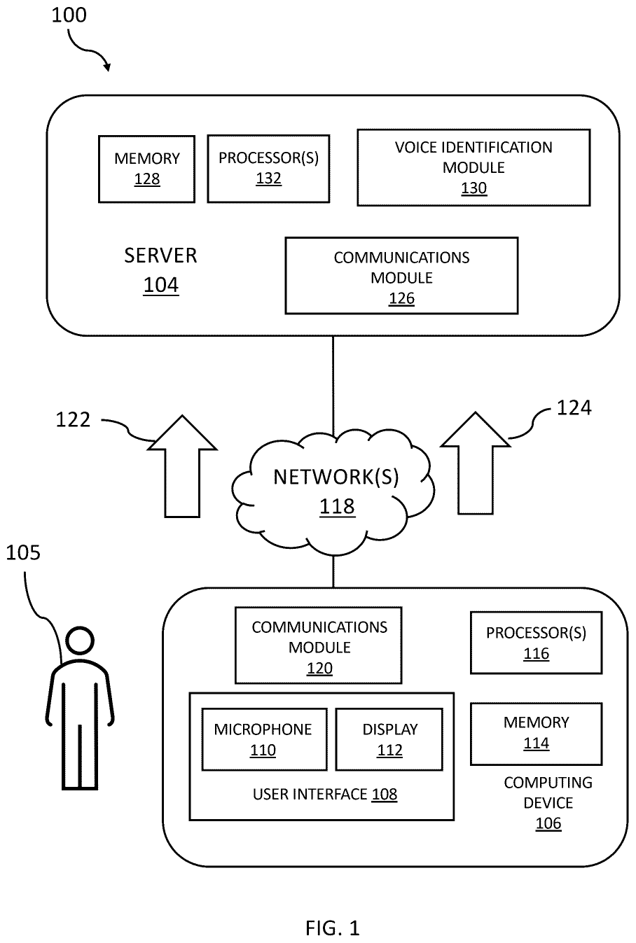

FIG. 1 illustrates a block of system 100 for authenticating a user 102 based on analysis of the user's voice in accordance with embodiments of the present disclosure. Referring to FIG. 1, the system 100 includes a server 104 and a computing device 106 of the user 102. The computing device 106 may include a user interface 108 for interaction with the user 102. For example, the user interface 108 may include a microphone 110 and a touchscreen display 112. The touchscreen display 112 may controlled to display prompts, graphics, text, and the like to a user for interaction in accordance with embodiments of the present disclosure. For example, the touchscreen display 112 may display text, graphic, or other prompt for prompting the user to speak for authenticating the user's voice. The user may be prompted to speak any word or words for authenticating the user. In some examples, the user may be prompted to speak a passphrase presented to the user by the touchscreen display 112. The microphone 110 may receive the acoustic energy (or sound waves) of the user's speech and convert the acoustic energy into an electrical signal. The computing device 106 may suitably convert the electrical signal into voice data for storage within memory 114 of the computing device 106.

The user 105 may also provide an identifier for the user. Example identifiers include, but are not limited to, a username, email address, user ID, account number, and the like. Further, the user may provide another identifier for further validating the identity of the user 105. The other identifier may include, but are not limited to, passwords, personal identification numbers (PINs), security questions/answers, a user identifying number, a telephone number, and the like. These identifiers may be suitably entered via the user interface 108 and stored in memory 114. For example, the user 105 may suitably interact with the touchscreen display 112 for inputting user input that indicates the identifier.

The functionalities of the computing device 106 described herein may be implemented by suitable hardware, software, and/or firmware of the computing device 106. In an example, functionalities of the computing device 106 may be implemented by one or more processors 116 running instructions stored in memory 114. In another example, the computing device 106 may have one or more applications (or “apps”) configured to implement the functionalities described herein.

The computing device 106 may be communicatively connected to the server 104 for communication of the stored voice data and identifier of the user 105 to the server 104 for authentication of the user 105. For example, the computing device 106 and the server 104 may be in an active communication session, such as a voice-based communication session. One or more communications networks 118 can communicatively connect the computing device 106 and the server 104. Example communications networks include, but are not limited to, local area networks, wide area networks, wireless networks, and cellular networks. The computing device 106 may include a communications module 120 configured to communicate the user input 122 that indicates the identifier of the user and the voice data 124 associated with the user 105 to the server 104 via the communications network(s) 118. The server 104 may include a communications module 126 for receipt of the user input 122 and the voice data 124. The user input 122 and the voice data 124 may be stored in memory 128 of the server 104.

Subsequent to storage of the user input 122 and the voice data 124 in memory 126, a voice identification module 130 may access the stored user input 122 and the voice data 124 for analysis and authentication of the user 105 in accordance with embodiments of the present disclosure. Functionalities of the voice identification module 130 as described herein can be implemented by suitable hardware, software, and/or firmware. For example, functionalities of the voice identification module 130 may be implemented by one or more processors 132 running instructions stored in memory 128.

The voice identification module 130 can analyze the voice data 124 of the user 105 to generate one or more confidence metrics indicative of a consistency of the voice data 124 of the user 105 with stored voice data of an identified user. This stored voice data may be verified voice data of the user that has been identified by the provided user input 122. In examples, the voice identification module 130 can preprocess the voice data 124 prior to analysis. Further, the voice identification module 130 can apply noise reduction to the audio data, and/or convert the audio data into one or more feature representations for subsequent analysis. In embodiments, the voice identification module 130 can apply a spectrogram of the voice data 124 to identify unique features of the user's voice. Further, the voice identification module 130 can determine the confidence metric(s) based on the identified unique features of the user's voice. In examples, the voice identification module 130 can generate the confidence metric(s) by use of a convolutional autoencoder process, a long short term memory process, and/or a time delay neural network. The voice identification module 130 can determine whether the confidence metric(s) meets one or more criterion for authenticating the user's voice. Further, the voice identification module 130 can implement an action associated with authenticating the user associated with the received voice data and the identifier of the user in response to a determination that the confidence metric(s) meets the one or more criterion for authenticating a user's voice.

In embodiments, the voice identification module 130 can implement an action associated with authenticating the user associated with the received voice data 124 and the identifier 122 of the user in response to a determination that the confidence metric(s) meets the one or more criterion for authenticating a user's voice. For example, the user 105 may be authenticated in response to the determination that the confidence metric(s) meets the one or more criterion for authenticating a user's voice. In examples subsequent to authentication, the user 105 can be permitted to access financial data, security data, and the like at server 104 subsequent to authentication.

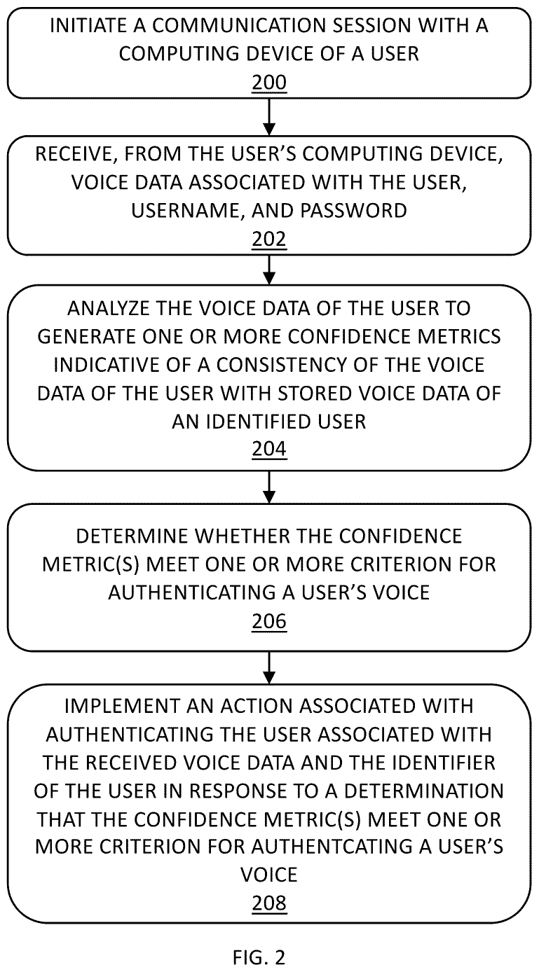

FIG. 2 illustrates a flow diagram of a method for authenticating a user based on analysis of the user's voice in accordance with embodiments of the present disclosure. The method of FIG. 2 is described by example as being implemented by the system 100 shown in FIG. 1. However, it should be understood by those of skill in the art that the method may be implemented by any other suitable system.

Referring to FIG. 2, the method includes initiating 200 a communication session with a computing device of a user. For example, a voice-based communication session or other suitable communication session between the server 104 and the computing device 106 may be initiated and maintained via the communications network(s) 118. In an example, an app residing on the computing device 106 may be used to access services provided by functionalities of the server 104.

The method of FIG. 2 includes receiving 202, from the user's computing device, voice data associated with the user, username, and password. Continuing the aforementioned example, the user 105 may interact with computing device 104 for implementing functions of the app. The app may initiate communication with the server 104. In order to access secure data or other functions of the server 104, authentication of the user may be required. The app may prompt the user 105 via the display 112 or other user interface component to speak. In examples, the server 104 may send to the computing device 106 a request for username and/or password upon initiation of a communication session or other session with the app of the computing device 106. The username and/or password can be used for identifying the user 105. Further, the server 104 may send to the computing device 106 a passphrase for prompting input of voice by the user 105. The request for username and/or password and the passphrase may be suitably presented to the user 105 via the user interface 108. The prompt may be presented by text, graphically, sound, and/or the like. In response to the prompt, the user 105 may use the user interface for suitably entering requested username and/or password (e.g., by typing or speaking). Further in response to the prompt, the user 105 may use the user interface 108 to enter the passphrase by speaking into the microphone 110. The computing device 106 may communicate the entered username and/or password, and voice data corresponding to the spoken passphrase to the server 104.

The method of FIG. 2 includes analyzing 204 the voice data of the user to generate one or more confidence metrics indicative of a consistency of the voice data of the user with stored voice data of an identified user. Continuing the aforementioned example, the voice identification module 130 can analyze the voice data of the user to generate one or more confidence metrics indicative of a consistency of the voice data of the user 105 with stored voice data of an identified user. The voice identification module 130 can analyze the spoken passphrase to determine that the spoken passphrase matches the user's 105 voice and that the spoken passphrase in the received voice data matches the passphrase. Further, the voice identification module 130 can authenticate the user 105 based on the determination that the spoken passphrase in the received voice data matches the passphrase and the determination that the spoken passphrase matches the user's voice.

The method of FIG. 2 includes determining 206 whether the confidence metric(s) meet one or more criterion for authenticating a user's voice. Continuing the aforementioned example, the voice identification module 130 can determine the confidence metric(s) based on the identified unique features of the user's voice. In examples, the voice identification module 130 can generate the confidence metric(s) by use of a convolutional autoencoder process, a long short term memory process, and/or a time delay neural network. The voice identification module 130 can determine whether the confidence metric(s) meets one or more criterion for authenticating the user's voice. Further, the voice identification module 130 can implement an action associated with authenticating the user associated with the received voice data and the identifier of the user in response to a determination that the confidence metric(s) meet the one or more criterion for authenticating a user's voice. The user 105 can be authenticated based on the determination that the spoken passphrase in the received voice data matches the passphrase and the determination that the spoken passphrase matches the user's voice.

The method of FIG. 2 includes implementing 208 an action associated with authenticating the user associated with the received voice data and the identifier of the user in response to a determination that the confidence metric(s) meets one or more criterion for authenticating a user's voice. Continuing the aforementioned example, the voice identification module 130 can implement an action associated with authenticating the user associated with the received voice data 124 and the identifier 122 of the user in response to a determination that the confidence metric(s) meets the one or more criterion for authenticating a user's voice. For example, the user 105 may be authenticated in response to the determination that the confidence metric(s) meets the one or more criterion for authenticating a user's voice. In examples subsequent to authentication, the user 105 can be permitted to access financial data, security data, and the like at server 104 subsequent to authentication.

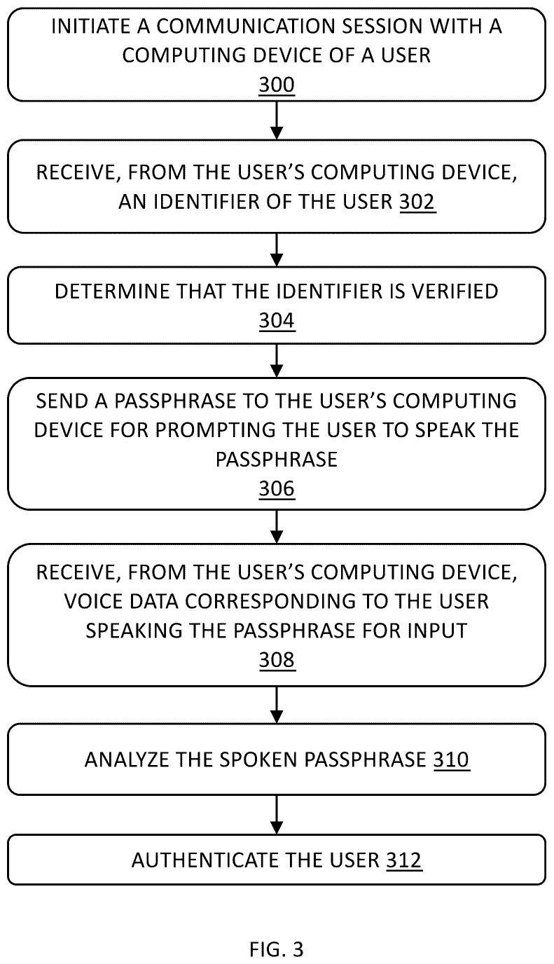

FIG. 3 illustrates a flow diagram of a method for authenticating a user based on analysis of the user's voice in accordance with embodiments of the present disclosure. The method of FIG. 2 is described by example as being implemented by the system 100 shown in FIG. 1. However, it should be understood by those of skill in the art that the method may be implemented by any other suitable system.

Referring to FIG. 3, the method includes initiating 300 a communication session with a computing device of a user. For example, a voice-based communication session or other suitable communication session between the server 104 and the computing device 106 may be initiated and maintained via the communications network(s) 118. In an example, an app residing on the computing device 106 may be used to access services provided by functionalities of the server 104.

The method of FIG. 3 includes receiving 302, from the user's computing device, an identifier of the user. Continuing the aforementioned example, the user 105 may enter an identifier such as a username, a user identifying number, and/or a telephone number. The computing device 106 may send the identifier to the server, where the identifier is received and stored.

The method of FIG. 3 includes determining 304 that the identifier of the user is verified. Continuing the aforementioned example, the voice identification module 130 can review the received identifier for verification. For example, the identifier may be compare the identifier to an approved list.

The method of FIG. 3 includes sending 306 a passphrase to the user's computing device for prompting the user to speak the passphrase in response to the determination that the identifier of the user is verified. Continuing the aforementioned example, the voice identification module may generate and control the communications module 126 to send a passphrase to the user's computing device 106. The passphrase may be sent in response to the determination that the identifier of the user is verified. The computing device 106 may receive the passphrase and present the passphrase to the user 105 via the user interface 108 for prompting the user to speak the passphrase.

The method of FIG. 3 includes receiving 308, from the user's computing device, voice data corresponding to the user speaking the passphrase for input. Continuing the aforementioned example, the user may speak the passphrase into the microphone 110. The computing device 106 may subsequently generate voice data corresponding to the spoken passphrase, and send the generated voice data to the server 104, where the voice data is received and stored in memory 128.

The method of FIG. 3 includes analyzing 310 the spoken passphrase to determine that the spoken passphrase matches the user's voice and that the spoken passphrase in the received voice data matches the sent passphrase. Continuing the aforementioned example, the voice identification module 130 can analyze the spoken passphrase to determine that the spoken passphrase matches the user's voice and that the spoken passphrase in the received voice data matches the sent passphrase. The voice identification module 130 can determine that the spoken passphrase matches the user's voice by use of a convolutional autoencoder process, a long short term memory process, and/or a time delay neural network.

The method of FIG. 3 includes authenticating 312 the user based on the determination that the spoken passphrase in the received voice data matches the passphrase, the determination that the spoken passphrase matches the user's voice, and that the spoken passphrase is received within a predetermined time period subsequent to sending the passphrase to the user's computing device. Continuing the aforementioned example, the voice identification module 130 can authenticate the user 105 in response to determining that the spoken passphrase in the received voice data matches the passphrase, the determination that the spoken passphrase matches the user's voice, and that the spoken passphrase is received within a predetermined time period subsequent to sending the passphrase to the user's computing device. The time period may be a few seconds (e.g., about 5 second or less).

In accordance with embodiments, a communication with the computing device 106 may be initiated in one modality, while the passphrase is sent to the user's computing device 106 is sent via another modality different than the initial modality. For example, the initial modality may be a voice-based modality or suitable modality via an app residing on the computing device 106. The second modality may be an SMS-based communication modality, a chat-based communication modality, or an email-based communication modality.

In accordance with embodiments, the voice identification module 130 is configured to utilize a virtual agent and/or a virtual avatar for implementing the communication session. In example, the voice identification module 130 can utilize a virtual avatar based on a virtual agent, an avatar visual component, and an avatar audio component. The virtual avatar may be a physical representation of a virtual agent. For example, a portrait image of a person may be captured, and the image animated with lip syncing the visual features of the mouth with the audio being generated by the virtual agent. Other facial expressions can be synchronized to moods as well.

Machine learning (ML) and deep learning (DL) techniques can be utilized for implementing the systems and computer-implemented methods disclosed herein. ML and DL techniques can enable the extraction, modeling, and comparison of complex vocal characteristics for purposes of identification, authentication, and fraud detection. These techniques allow systems and computing-implemented methods disclosed herein to process voice data at scale while remaining resilient to variability in speech patterns, environmental noise, and transmission quality.

Some authentication systems can on ML models such as Gaussian Mixture Models (GMMs) and Support Vector Machines (SVMs), which operate on acoustic features extracted from audio signals. While effective in constrained environments, such approaches may be limited in their ability to generalize across diverse speakers, languages, and real-world conditions. These limitations motivated the adoption of deep learning architectures capable of learning rich representations directly from voice data.

Systems and computer-implemented methods disclosed herein can use more modern DL models such as deep neural networks (DNNs), convolutional neural networks (CNNs), recurrent neural networks (RNNs), long short-term memory (LSTM) networks, time-delay neural networks (TDNNs), and combinations thereof. These architectures are well suited for analyzing both spectral and temporal aspects of speech, enabling the system to capture fine-grained biometric features such as vocal timbre, cadence, pronunciation dynamics, and frequency modulation.

In some embodiments, systems and computer-implemented methods disclosed herein can utilize speaker embedding models that generate compact numerical representations of a speaker's voice. These embeddings encode speaker-specific characteristics in a manner that facilitates efficient comparison across sessions and communication channels. Speaker embedding models may be trained using supervised, semi-supervised, or self-supervised learning techniques and may include architectures commonly used in speaker recognition tasks, such as x-vector-style models, ECAPA-based models, or functionally similar embedding networks. The specific model architecture is not limiting, and alternative embedding techniques may be substituted without departing from the scope of the invention.

In addition to embedding-based approaches, systems and computer-implemented methods disclosed herein may employ autoencoder-based models, including convolutional autoencoders, to learn latent representations of a user's voice. Autoencoders can be trained to reconstruct input voice representations, such as spectrograms, and may be optimized to accurately reconstruct voices associated with authorized users while producing higher reconstruction error for unauthorized or unfamiliar voices. These reconstruction errors may serve as indicators of identity mismatch, spoofing attempts, or anomalous behavior.

In some embodiments, systems and computer-implemented method disclosed herein can operate as a hybrid system or method, combining outputs from multiple model types. For example, speaker embeddings generated by an embedding model may be used alongside reconstruction error metrics produced by an autoencoder. Confidence scores or metrics derived from these components may be aggregated, weighted, or otherwise fused to produce a final identity or risk determination. This multi-model approach improves robustness and reduces susceptibility to single-model failure modes, including replay attacks, synthetic speech, or partial voice impersonation.

ML models within systems disclosed herein may be trained and updated using supervised data, augmented data, or continuously collected samples, allowing the system to adapt to natural changes in a user's voice over time. Training and inference may occur on centralized servers, distributed systems, or edge devices, depending on deployment requirements. By employing modular and extensible ML and DL components, systems and computer-implemented methods disclosed herein remain adaptable to future advancements in voice modeling, anti-spoofing techniques, and computational architectures.

Systems and computer-implemented methods disclosed herein may utilize one or more voice authentication, speaker identification, and signal processing techniques to analyze voice data and determine identity, authenticity, or risk. Techniques described herein are provided as illustrative examples and are not intended to limit the scope of the presently disclosed subject matter. Various techniques may be used independently or in combination, depending on the implementation, deployment environment, or security requirements.

In embodiments, systems and computer implemented-methods disclosed herein may utilize various authentication techniques in combination with other techniques described herein. In an example, text-dependent authentication may be utilized and relies on pattern-matching or signal-processing techniques to compare the user's spoken phrase to a stored recording for authentication. In another example, Formant analysis may be used to measure specific frequency bands (formants) in a person's voice that are influenced by the shape of their vocal tract. These patterns are compared to stored data for authentication. In another example, pitch and frequency analysis may be utilized, and it utilizes statistical methods to analyze the pitch, frequency, and amplitude of a user's voice. It matches these characteristics against pre-recorded templates. In another example, spectral analysis may be utilized, and it examines the spectral energy distribution of voice signals to identify unique voice patterns. This method typically involves signal processing rather than AI. In another example, template matching may be utilized, and it involves comparing a user's voice sample with a stored template using basic pattern recognition algorithms. In another example, Dynamic Time Warping (DTW) may be utilizes and involves matching the time-dependent aspects of speech, such as cadence and intonation, between a sample and a stored reference. It does not require AI but works well for fixed phrases. In another example, cepstral analysis may be utilizes, and it extracts cepstral coefficients (features derived from a signal's frequency spectrum) to analyze voice characteristics. In this example, statistical methods may be used to compare these coefficients for authentication. In another example, Harmonics-to-Noise Ratio (HNR) may be used to analyze the ratio of harmonic components to noise in a voice signal to differentiate between individuals. This technique is based on basic acoustic analysis. In another example, a Linear Predictive Coding (LPC) technique may be used, and it models the vocal tract using a mathematical approach to predict voice signal properties. LPC features are then compared with stored data for verification. In yet another example, signal energy analysis may be implemented to use the energy levels in voice signals to distinguish between users. It is a simple but less secure approach. In another example, voice duration and tempo analysis may be used to evaluate the length of speech and rhythm to identify unique patterns. It is often used in conjunction with other non-AI methods.

In some embodiments, systems and computer-implemented methods may be AI based for authentication. In an example, text-independent authentication can be used and relies on machine learning to analyze complex vocal patterns and unique features like pitch, tone, and rhythm without needing specific phrases. In another example, speaker embedding models can use AI to create numerical embeddings of a user's voice, capturing unique characteristics for comparison. In another example, dynamic passphrases may be used and involves analyzing both the passphrase content and the voice's biometric features dynamically. In another example, biometric fusion may be utilized and involves AI algorithms integrate voice data with other biometric inputs, such as facial recognition, for multi-modal verification. In another example, voice liveness detection may be utilized and employs AI to distinguish between live voices and playback attacks, analyzing speech patterns and contextual audio cues. In another example, noise-robust authentication may be implemented and uses AI-powered noise cancellation and feature extraction techniques to ensure accurate authentication in noisy environments. In another example, deep neural networks (DNNs) may be implemented and uses deep learning models to analyze complex voice features such as timbre, rhythm, and speech dynamics. DNNs can identify intricate patterns in a user's voice. In another example, convolutional neural networks (CNNs) can be implemented, and it processes spectrograms (visual representations of sound) to extract unique features for voice authentication. CNNs are particularly effective for image-like input data. In another example, recurrent neural networks (RNNs) and LSTMs may be used, and involves handling sequential data like speech, these models analyze temporal patterns in voice signals, such as cadence and intonation. In another example, transformers may be utilized and involves advanced models like the Speech Transformers process entire speech sequences simultaneously, offering high efficiency and accuracy in capturing voice nuances. In another example, self-supervised learning may be utilized, and it models learn voice characteristics from large, unlabeled datasets before fine-tuning on smaller labeled datasets for authentication, reducing the need for extensive labeled data. In another example, generative adversarial networks (GANs) may be used to improve the robustness of voice authentication by generating synthetic voice samples for training, helping systems detect spoofing attacks. In another example, zero-shot learning may be used to enable authentication of new users with minimal enrollment data by leveraging pre-trained models to generalize voice patterns across individuals. In another example, speaker diarization may be used to separate and identify speakers in multi-speaker environments using AI models, which can also be adapted for authentication in dynamic scenarios. In another example, voice anti-spoofing models with AI systems may be specifically designed to detect and counter spoofing attacks like voice synthesis or replay attacks. These models analyze subtle inconsistencies in voice signals. In another example, federated learning for voice authentication may be used to enable decentralized model training on user devices to preserve privacy while enhancing the accuracy of voice biometrics. In another example, acoustic scene analysis with AI may be used to integrate contextual data such as background noise and environment to authenticate users more accurately and detect anomalies. In another example, phoneme-level analysis may be used with AI modeling to analyze phonemes (distinct sound units in speech) for highly granular voice authentication. This improves precision, especially for multilingual users. In another example, adaptive voice models with AI systems may be used to continuously learn and adapt to variations in a user's voice over time, such as changes due to aging or illness. In another example, emotion-aware voice authentication using AI may factor in emotional tones in voice signals, distinguishing between deliberate attempts at authentication and involuntary speech. In another example, AI systems may use attention layers to focus on the most critical voice features during analysis, improving both accuracy and efficiency. Systems and methods disclosed herein may employ any combination of these techniques depending on the application, security level, or operating environment. In some embodiments, outputs from multiple techniques may be combined, weighted, or evaluated collectively to generate a confidence score, authentication decision, or fraud risk signal.

In embodiments, two-factor authentication (2FA) technology described herein combines a dynamic passphrase and voice-based authentication to provide a secure and user-friendly method for verifying identity. These systems and computer-implemented methods can involve two complementary factors: a dynamically generated passphrase (“what you know”) and the unique biometric characteristics of a user's voice (“who you are”). Users are provided with a random or bespoke passphrase, which they are required to speak aloud during an active communication session, allowing the system to verify both the content of the passphrase and the authenticity of the speaker's voice.

In embodiments, the authentication process can begin with generating and delivering a unique passphrase to the user through a secure communication channel. The user's spoken passphrase can be captured and processed to validate the correctness of the phrase and to analyze the biometric characteristics of the speaker's voice. The spoken audio may be converted into one or more representations, including spectrograms or other feature-based formats, and analyzed using machine learning techniques to determine whether the voice matches an enrolled or previously observed speaker.

In embodiments, systems and computer-implemented methods can utilize convolutional autoencoders (CAEs) trained to learn latent representations of a user's voice. These autoencoders are optimized to accurately reconstruct voice representations associated with authorized users while producing higher reconstruction error for unauthorized or unfamiliar voices. The resulting reconstruction error may be used as an indicator of identity match, mismatch, or anomalous behavior. In addition to autoencoder-based analysis, systems and computer-implemented methods may incorporate speaker embedding models that generate compact numerical representations of a speaker's voice. Outputs from one or more models may be evaluated independently or in combination to improve overall confidence, robustness, and resistance to spoofing or impersonation attempts.

Systems and computer-implemented methods disclosed herein can operate in real time and may be deployed in environments where voice-based communication is already present, including, but not limited to, telephony systems, virtual agents, automated call handling platforms, and other voice-enabled interfaces. By requiring that the passphrase be spoken within a defined period of time during the communication session, the system can reduce the risk of replay attacks, delayed synthesis, or other spoofing techniques. The time-bound and session-specific nature of the passphrase further enhances security against automated or pre-recorded attacks.

In embodiments, systems and computer-implemented methods disclosed herein may associate authenticated voices with identifying information provided during the communication session. Such identifying information may include, but are not limited to, user identifiers, account identifiers, phone numbers, or regulatory identifiers. In certain implementations, regulatory identifiers may include Department of Transportation (DOT) numbers, Motor Carrier (MC) numbers, or similar identifiers, which are provided as non-limiting examples. Systems and computer-implemented methods disclosed herein may operate using any identifier or combination of identifiers suitable for a given deployment environment.

This association enables the system to evaluate whether a voice presented during a communication session corresponds to an expected or previously observed voice associated with a given identifier or set of identifiers. In addition to authentication, systems and computer-implemented methods disclosed herein may function as a monitoring, warning, or fraud-detection system. For example, a system may detect when the same voice is associated with multiple distinct identifiers, such as different DOT numbers, MC numbers, or other regulatory or account identifiers, across separate communication sessions. Such occurrences may indicate fraud, impersonation, or unauthorized credential sharing.

When such conditions are detected, systems and computer-implemented methods disclosed herein may generate alerts, warnings, or risk signals for further review, automated handling, or escalation to human operators. By combining dynamic passphrases, biometric voice analysis, and flexible machine learning architectures, systems and computer-implemented methods disclosed herein provides a secure, scalable, and adaptable framework for voice-based identification and authentication. The system is particularly well suited for high-risk and high-volume environments, including logistics, transportation, finance, and customer service operations, where identity assurance and fraud prevention are critical.

In embodiments, systems and methods disclosed herein involve voice-based identification and authentication for analyzing biometric voice characteristics in conjunction with session-based information to determine identity, authenticity, or risk. The system may operate during live communication sessions, including voice calls, virtual agent interactions, or other voice-enabled interfaces, and may be deployed across centralized, distributed, or edge-computing environments.

In embodiments, systems and methods disclosed herein operate as a modular system comprising multiple functional components configured to perform voice-based identification and authentication during an active communication session. These components may include an audio ingestion module, a preprocessing module, one or more voice analysis models, a decision or signaling module, and an optional secondary authentication module.

Audio input may be captured from a user during a live communication session, such as a telephone call, virtual agent interaction, or other voice-enabled interface. The captured audio may undergo preprocessing, including noise reduction and conversion into one or more feature representations suitable for analysis, such as spectrograms generated using short-time Fourier transform (STFT) or Mel-scale processing.

The user may provide identifying information during the communication session, such as a name, account identifier, phone number, or regulatory identifier (e.g., Department of Transportation (DOT) number, Motor Carrier (MC) number, or similar identifier). Based on the provided identifying information, the system may select one or more voice models associated with the identifier for evaluation.

The processed audio can be analyzed using the selected voice model(s) to compute one or more confidence metrics. In some embodiments, this analysis includes passing the audio features through a convolutional autoencoder (CAE) to compute a reconstruction error indicative of whether the voice is consistent with previously observed or enrolled voice data associated with the identifier.

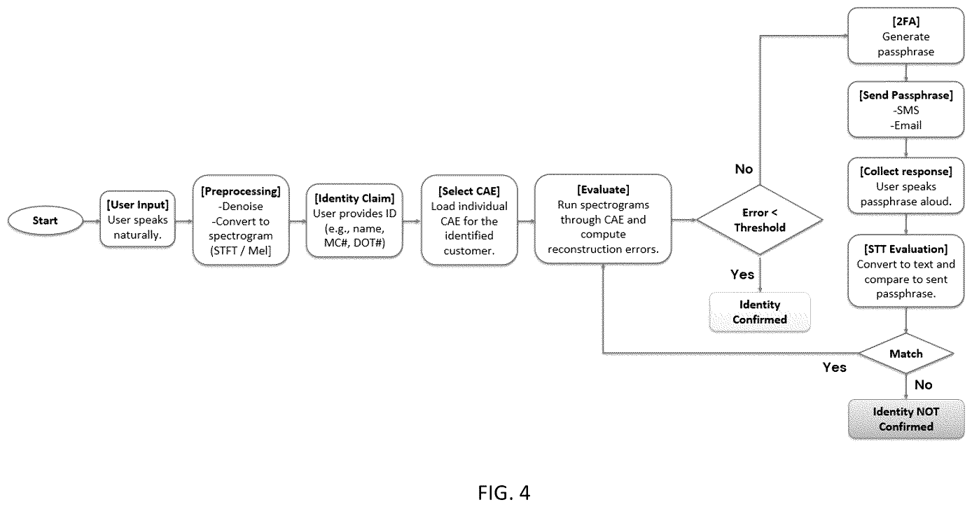

FIG. 4 illustrates a diagram depicting system architecture and operational flow for systems disclosed herein that implement voice-based identification with optional dual-factor authentication in accordance with embodiments of the present disclosure. Referring to FIG. 4, In this manner, the system selectively escalates authentication requirements based on computed confidence metrics, such that secondary authentication is dynamically invoked only when voice-based confidence falls below one or more thresholds.. In this secondary process, the system generates a dynamic or bespoke passphrase and transmits the passphrase to the user through an alternate communication channel, such as SMS or email. The user is prompted to speak the passphrase aloud during the communication session.

The spoken passphrase may be evaluated using speech-to-text processing to determine whether the spoken content matches the generated passphrase. Identity confirmation may be based on a combination of voice biometric analysis results and passphrase verification. If the spoken passphrase does not match or if the voice analysis fails to meet the required criteria, the system may deny authentication, generate a warning or alert, or request additional verification.

The operational flow illustrated in FIG. 4 is provided for illustrative purposes. Alternative component arrangements, decision logic, model architectures, or communication channels may be used without departing from the scope of the present disclosure.

A convolutional autoencoder (CAE) is a type of neural network that may be used by systems and computer-implemented methods disclosed herein to analyze voice data by learning an efficient encoding of voice features. In certain embodiments, individual convolutional autoencoders may be trained for specific users or speakers. Each such model may be trained primarily or exclusively on voice samples associated with a given speaker.

The objective of the CAE is to reconstruct input voice representations, such as spectrograms, with minimal error when the input corresponds to an authorized or previously observed speaker, and with higher error when the input corresponds to an unauthorized or unfamiliar speaker. This behavior allows reconstruction error to be used as a signal for authentication, identification, or anomaly detection.

A CAE may include an encoder, a bottleneck layer (latent space), and a decoder. The encoder compresses the input data into a low-dimensional representation (latent space), extracting key features of the user's voice. It consists of convolutional layers that identify patterns like pitch, tone, and frequency variations. The bottleneck layer is the compressed representation of the voice. Further, the representation acts as a fingerprint of the user's voice, containing enough information to reconstruct the input spectrogram. The decoder takes the compressed representation and reconstructs the original spectrogram. Further, the decoder mirrors the encoder, using convolutional transpose (or up sampling) layers.

The CAE may be trained with input data. The input to the CAE is the spectrogram of the user's voice. A spectrogram is a time-frequency representation of an audio signal, providing a visual way to analyze sound. The CAE may include a forward pass in which the spectrogram is passed through the encoder, bottleneck, and decoder to produce a reconstructed version of the input. Further, the CAE involves loss calculation in which the reconstruction loss (e.g., Mean Squared Error, MSE) is computed as the difference between the input spectrogram and the reconstructed spectrogram. An example loss formula follows:

$$Loss = \frac{1}{N} {\sum }_{i = 1}^{N} {( {Original}_{i} - {Reconstructed}_{i} )}^{2}$$

In a step of backpropagation and optimization, gradients can be calculated and propagated back through the network. Weights are updated using an optimizer like Adam or RMSprop to improve reconstruction accuracy.

CAE authentication may involve an enrollment phase, an authentication phase, and threshold comparison. The enrollment phase involves the CAE learning, during training, to reconstruct only the enrolled user's voice spectrograms. Reconstruction error for the user's voice is low because the model specializes in capturing their unique patterns. The authentication phase includes a new voice sample being converted into a spectrogram and passed through the CAE. The CAE may attempt to reconstruct the spectrogram. Reconstruction errors are calculated by low error (which indicates that the voice belongs to the enrolled use), and high error that suggests the voice does not match the user, as the CAE struggles to reconstruct unfamiliar patterns.

Threshold comparison for CAE authentication involves a threshold being set based on the reconstruction error distribution of the training data. In some embodiments, the thresholding process may incorporate regularization or normalization techniques, such as score smoothing, margin constraints, adaptive thresholding, or aggregation across multiple samples, to reduce sensitivity to noise, session variability, or transient speech artifacts. In some embodiments, the reconstruction error may be evaluated in combination with outputs from one or more additional voice analysis models to generate an authentication decision or risk signal. If the resulting score satisfies the threshold criteria, the system authenticates the user; otherwise, authentication is denied or additional verification may be requested.

Example mathematical representation of encoding, decoding, and loss function follows. For encoding, input spectrogram X is passed through convolutional layers to extract features:

$$Z = {f}_{Encoder} ( X ; {θ}_{Encoder} )$$

where Z is the bottleneck representation, and θ_{Encoder} are the weights of the encoder.

For decoding, the bottleneck representation Z is passed through the decoder to reconstruct the spectrogram:

$$\hat{X} = {f}_{Decoder} ( X ; {θ}_{Decoder} )$$

where \hat{X} is the reconstructed spectrogram, and θ_{Decoder} are the weights of the decoder.

For loss function, the loss function minimizes the difference between X and X:

$$ℒ = {‖ X - \hat{X} ‖}^{2}$$

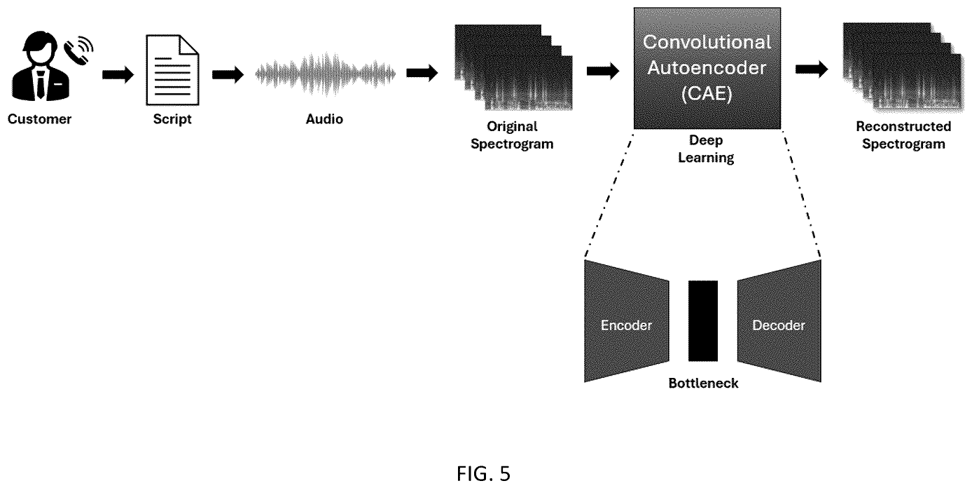

FIG. 5 is a diagram depicting a voice authentication pipeline using Convolutional Autoencoders in accordance with embodiments of the present disclosure.

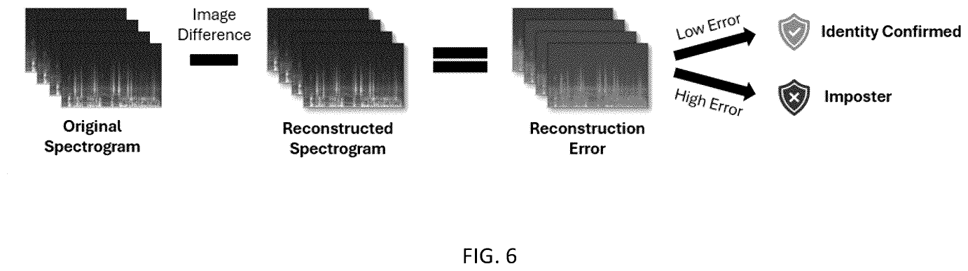

FIG. 6 is a diagram depicting spectrogram reconstruction error for voice authentication in accordance with embodiments of the present disclosure.

The visual representations shown in FIGS. 5 and 6 are provided for illustrative purposes, and alternative model architectures, data flows, or visual arrangements may be used without departing from the scope of the present disclosure.

Voice data must be processed carefully to transform raw audio signals into a format suitable for use in a CAE. This process involves several steps, including preprocessing, feature extraction, and preparation for model training. Below is a detailed explanation of each step.

Audio data preprocessing can include data collection, noise reduction, and voice activity detection (VAD). Data collection involves recording and collecting voice samples in suitable formats (e.g., WAV, MP3, FLAC). Further, data collection includes using a fixed script to maintain consistency across samples, such as predefined phrases. Further data collection includes using a suitable sampling rate involving resampling all recordings to a fixed sampling rate. These sampling rates may be, for example, 16 kHz: for speech processing, and 8 kHz: suitable for telephony-grade audio. This ensures uniformity across all data. Data collection can also include mono conversion, which involves converting audio to mono (single channel) if it's stereo, as most speech features are adequately captured in mono. Noise reduction can include removing background noise to ensure clean audio input. VAD can include removing silent or non-speech segments to focus on the relevant parts of the audio signal.

CAE models can include feature extraction, which can require structured input like spectrograms rather than raw waveforms. An example transformation include, but are not limited to, short-time Fourier transforms (STFT), which converts the audio signal into a spectrogram, a 2D representation of frequency over time. Another example transformation includes Mel spectrogram, which projects the spectrogram onto the Mel scale, which better aligns with human auditory perception. Another example transformation is Mel-Frequency Cepstral Coefficients (MFCCs), which compresses the Mel spectrogram into compact features commonly used in speech processing. In an example, the extracted features may be normalized to scale values between 0 and 1, ensuring consistent input for the CAE. In another example, features may be padded or truncated to a fixed size (e.g., 128×128) to ensure uniform input dimensions for the CAE.

Data augmentation can be used to improve model robustness by simulating real-world variations in voice data. Such augmentation can include adding noise by injecting Gaussian noise to simulate background environments. In another example, time stretching may be used to speed up or slow down the audio without changing the pitch. In another example, pitch shifting may be used to shift the pitch up or down to account for tonal variations.

In embodiments, data may be structured for CAE. In an example of data shaping, preprocessed spectrograms may be converted into 3D tensors of shape (e.g., samples, height, width, channels). Samples can be a number of audio samples. Height can be a number of frequency bins. Width can be a number of time steps. Channels can be a number of audio channels (e.g., 1 for mono). Further, the dataset may be split into training and validation/test sets (e.g., 80/20). Batches of spectrograms may be used for training the CAE.

Processed voice data may be fed into the CAE as input tensors. The CAE can process this data to learn the unique features of the user's voice.

In embodiments, two-factor authentication (2FA) may be implemented by systems and computer-implemented methods disclosed herein. In digital security, some authentication such as passwords or PINs are increasingly vulnerable to breaches and unauthorized access. To address these challenges, voice-based two-factor authentication (2FA) offers a highly secure and user-friendly solution by combining the verification of a dynamic passphrase with unique voice biometrics. The present disclosure can enhance security by requiring users to first receive a generated passphrase and then speak it aloud, ensuring that both the knowledge of the passphrase and the physical trait of the user's voice are verified.

The integration of passphrase verification and voice recognition introduces a robust layer of security, making it particularly suitable for high-risk applications in finance, healthcare, and logistics. The generated passphrase serves as a dynamic authentication factor that changes with each session, effectively mitigating the risks posed by static credentials. Advances in speech processing and machine learning can enable the system to validate the spoken passphrase through speech-to-text technology and authenticate the user's voice using convolutional autoencoders.

Furthermore, this dynamic combination of passphrase and voice biometrics can provide an effective defense against modern threats like deepfakes and voice cloning. Unlike traditional voice authentication systems that rely solely on matching static voice patterns, this approach can dynamically generate a unique passphrase for each session, which the user must speak aloud. This ensures that even if an attacker has access to a cloned voice or a deepfake audio sample, they cannot replicate the required passphrase in real time. Additionally, convolutional autoencoders analyze the subtle nuances of the user's voice, such as tone variations, speech cadence, and frequency patterns, which are difficult to replicate convincingly.

In some embodiments, the voice biometric analysis used as part of the second authentication factor may incorporate outputs from multiple voice analysis models, evaluated independently or in combination, to increase robustness and confidence.

In embodiments, a system as disclosed herein can generate, as a first factor, a unique passphrase and sends it to the user via a secure communication channel, such as text message, application notification, or email. In a second factor, the user speaks the passphrase aloud during an active communication session. Passphrase verification includes verifying that that the spoken phrase matches the generated passphrase using speech-to-text or similar techniques. Further, the system verifies the speaker's voice against previously trained voice models associated with the user or identifier.

A passphrase may be generated as a random, human-readable passphrase for each authentication session. Examples passphrases include, but are not limited to: “Secure Falcon 392” and “Green Maple 87”. The passphrase may be delivered to the user securely by, for example, via SMS using messaging APIs, via email using email delivery services, and via a mobile or web application using a notification system.

A user may speak the passphrase. For example, the user may be prompted to say the passphrase aloud. Audio input may be captured by, for example, use of a microphone or device API to record the user's speech, and saving the recording as a WAV or similar audio file. The recorded audio may be preprocessed by converting the spoken audio into a spectrogram using the same preprocessing pipeline used to train the CAE, and extracting text using speech-to-text for passphrase verification. The passphrase may be verified by, for example, comparing the transcribed text from the audio with the generated passphrase, and ensuring an exact match or allow minor discrepancies using string similarity or tolerance metrics. Voice authentication may be performed by, for example, converting the recorded audio into a suitable feature representation, analyzing the features using trained voice models to generate an authentication decision, and authenticating the user if both the passphrase verification and voice authentication succeed.

In embodiments, models may be personalized. For example, each user may be associated with one or more trained voice models, such as CAEs, capturing the unique characteristics of that person's voice, such as pitch, tone, accent, and speaking style. This personalized approach reduces the risk of false positives and increases the accuracy of authentication. In an example for high-security applications, such as systems like online banking or access to secure facilities, the unique characteristics captured by a user-specific CAE ensure that only the intended user is authenticated. Custom thresholds may be provided for users with distinct voice patterns (e.g., regional accents or speech impairments), the personalized model reduces the chances of false rejection or false acceptance.

Systems and computer-implemented methods disclosed herein may implement enhanced anomaly detection. Individual CAEs are optimized to reconstruct authorized voice spectrograms with minimal error. When an unauthorized or unfamiliar voice is processed, the reconstruction error is significantly higher, allowing the system to distinguish between genuine users and impostors. In diverse environments, where impostors may try to gain access (e.g., shared devices or public kiosks), the CAE's high reconstruction error for unauthorized users provides robust protection. CAEs trained on genuine voice data are less likely to reconstruct replayed audio or synthesized voices accurately, making it harder for attackers to spoof.

New users may be added by training separate models without requiring retraining of existing models. This allows the system to scale efficiently as the number of users grows. There may be no need to retrain or fine-tune a global model whenever a new user is added. Systems with growing user bases (e.g., a multi-user voice assistant) can add new users without needing to retrain a global model, allowing for rapid deployment. Each user's CAE can run locally on their device, such as smartphones or IoT gadgets, without dependence on a central server.

Systems and computer-implemented methods disclosed herein may provide robustness to impersonation. Since each CAE model is tailored to a specific user's voice, it is difficult for an impostor to replicate the precise characteristics learned by the model. Even deliberate attempts to mimic a voice are likely to result in higher reconstruction error. In corporate environments where voice authentication is used for employee access, individual CAEs reduce the risk of coworkers impersonating one another. When customers verify their identity via voice over a call, the model's ability to distinguish between genuine and impostor voices ensures better security.

Independent thresholds may be provided. For example, each user may have an independent authentication threshold based on their voice data, allowing security levels to be customized to individual users or risk profiles. This allows for fine-tuned security levels per user, accommodating natural variations in speaking style or recording environments. High-security users, such as executives, can have stricter thresholds, while general users can have more lenient settings to balance convenience and security. Thresholds can adapt to user-specific patterns over time, making the system more flexible and reducing false rejection rates.

Systems and computer-implemented methods disclosed herein can provide flexibility in model updates. If a user's voice characteristics change over time (e.g., due to aging, illness, or other factors), only their CAE needs retraining, leaving other users' models unaffected. Users can also re-enroll by providing fresh samples to retrain their individual CAE. For users whose voices may change due to aging, medical conditions, or environmental factors, retraining their individual CAE ensures continued accurate authentication. In customer-facing applications (e.g., call centers), users can re-enroll by simply providing new voice samples, making the system resilient to user updates.

User-specific models implemented by systems and computer-implemented methods disclosed herein can reduce reliance on shared global models containing voice data from multiple users, limiting exposure of biometric data across accounts. This decentralized structure reduces the risk of data leakage or unauthorized access to voice features from other users. In privacy-sensitive environments, such as personal devices or medical records, CAEs can operate locally, ensuring that users' voice data doesn't need to be uploaded to a central server. Meets data protection regulations (e.g., GDPR or CCPA) by minimizing data sharing between users or across systems.

Systems disclosed herein may be modular in that each CAE can operate independently, enabling a modular system where users' CAEs can run on separate devices or servers. This allows for distributed processing, reducing bottlenecks and making the system more resilient to single points of failure. In large-scale deployments (e.g., smart city infrastructure), individual CAEs can be deployed on edge devices, ensuring real-time authentication without overloading central servers. If one module (CAE) fails or becomes inaccessible, it doesn't affect the operation of other users' models, improving overall system resilience.

Systems disclosed herein can provide for incremental data collection. New data for a specific user can be incrementally added to their CAE without requiring access to or retraining of other users' models. This is particularly useful in dynamic environments where users may periodically update their enrolled voice samples. In systems that allow ongoing training, such as personalized voice assistants, users can add new samples periodically to improve the accuracy of their CAE without affecting others. Updates to a user's CAE don't require downtime or interference with other users, ensuring smooth system operation.

Systems disclosed herein can provide resistance to dataset bias. A single-user CAE is only exposed to the voice features of that user during training, avoiding biases introduced by other users' data. This ensures that the model is not influenced by characteristics irrelevant to the target user. For systems used across diverse populations (e.g., international customer support platforms), user-specific CAEs avoid biases introduced by other users' accents or speaking styles. In environments where users have unique needs (e.g., children, elderly users, or those with speech impairments), CAEs remain unbiased, as they only learn from their owner's data.

Example applications of systems and computer-implemented methods disclosed herein include voice biometric banking. Each customer's voice is authenticated using one or more trained voice models, such as a CAE. This ensures that even if an attacker gains access to one model, it won't compromise other accounts.

Another application is smart home devices. Personalized voice authentication for family members ensures that only authorized users can access sensitive controls or information (e.g., unlocking a smart lock or accessing payment details).

Another application is healthcare. Patients can use voice authentication for accessing telemedicine services. Individual CAEs provide enhanced security while ensuring personalized recognition.

Another application is call center authentication. CAEs help call centers verify customers' voices during interactions, reducing reliance on PINs or passwords.

In the logistics industry, transportation entities are commonly identified using regulatory or account-based identifiers. Examples of such identifiers may include Department of Transportation (DOT) numbers, Motor Carrier (MC) numbers assigned by the Federal Motor Carrier Safety Administration (FMCSA), or similar identifiers assigned by regulatory or industry organizations. These identifiers are frequently used during freight brokerage operations, load assignments, compliance checks, and payment verification processes. VoiceID may be used to enhance the security of interactions involving such identifiers by associating them with voice biometric data.

Freight brokers, shippers, and logistics service providers routinely interact with carriers and transportation entities using regulatory or account identifiers to verify identity during operational workflows. Unauthorized use of these identifiers may result in fraud, cargo theft, financial loss, or regulatory exposure. Fraudulent use of MC numbers by unauthorized parties can result in financial losses, shipment theft, and legal issues. Identifiers such as DOT numbers or MC numbers may be shared, stolen, or misused by unauthorized parties. Reliance on identifiers alone does not ensure that the individual presenting the identifier is authorized to act on behalf of the associated entity. Impersonation of authorized carriers by unauthorized parties is a growing concern.

Systems and computer-implement methods disclosed herein may be used to associate one or more voices with a given identifier during an enrollment process. During enrollment, an individual associated with a transportation entity may provide one or more voice samples along with an identifier, such as a DOT number or MC number. These samples may be used to train voice models or generate voice representations associated with the identifier.

During subsequent communications, such as inbound calls to a freight broker or virtual agent, the caller may provide an identifier and speak a phrase or command. Systems disclosed herein can analyze the caller's voice and compares it to previously observed or enrolled voice data associated with the provided identifier.

In embodiments, systems disclosed herein can operate as a carrier screener, evaluating whether the voice presented during a communication session is consistent with voices previously associated with the identifier. If the voice is consistent, the interaction may proceed normally. If the voice is inconsistent or anomalous, systems may flag the interaction for additional verification, review, or restricted access.

In addition to real-time screening, systems disclosed herein may function as a monitoring or warning system across multiple communication sessions. For example, the system may detect when the same voice biometric pattern is associated with multiple distinct identifiers, such as different DOT numbers, MC numbers, or other account identifiers, over time.

Such a pattern may indicate potential fraud, impersonation, or unauthorized credential sharing. When this condition is detected, systems may generate a warning, alert, or risk signal indicating that a particular voice has been observed using multiple identifiers. The alert may be used to prompt additional scrutiny, automated safeguards, or escalation to a human operator.

Systems disclosed herein can reduce unauthorized use of regulatory or account identifiers, improve trust and accountability in carrier interactions, enable proactive detection of fraud patterns across sessions, and integrate seamlessly with voice-based workflows such as call centers and virtual agents. This example illustrates how systems and computer-implemented methods disclosed herein may be applied in logistics and transportation environments. Other industries and use cases may similarly benefit from associating voice biometric data with identifiers and monitoring usage patterns over time.

Example workflow can include an enrollment phase involving carrier registration. During onboarding, each carrier may provide an identifier associated with the transportation entity, such as a Motor Carrier (MC) number, Department of Transportation (DOT) number, or similar identifier, along with a set of voice samples. Voice samples include predefined phrases such as: “My MC number is [number]” and “I am confirming my load assignment”. One or more voice models, such as CAEs, may be trained using the carrier's voice spectrograms to associate the voice biometric characteristics with the provided identifier.

When a carrier contacts a broker to claim or confirm a load, the carrier may provide an identifier (e.g., MC number or DOT number) and speak a voice command or phrase. The system verifies the identifier and analyzes the voice using one or more associated voice models. If the voice is consistent with previously enrolled or observed voice data associated with the identifier, the carrier may be authorized to access shipment or load details. During regulatory or compliance-related interactions, carriers may use voice authentication in conjunction with an identifier to verify identity, providing an additional biometric layer of assurance. Carriers calling to report shipment status, delays, or request changes may be authenticated using their identifier and voice prior to updating shipment records. Before processing or releasing payments, brokers may authenticate the carrier's identifier and voice to confirm delivery completion and authorization.

Voice authentication ensures that even if an identifier such as an MC number is stolen or shared, unauthorized parties cannot successfully use it without matching voice authentication. This protects against fraud and impersonation during load assignments and other operations.

Load assignments, shipment updates, and payment confirmations may be tied to authenticated voice interactions associated with an identifier, creating an auditable record for compliance and dispute resolution.

Authentication using voice and identifiers may be faster than manual identity checks, reducing delays during communications and operational workflow. New carriers may be added by training voice models for additional authorized individuals and associating them with an identifier, without disrupting existing operations. Unauthorized use of identifiers may be detected or prevented, protecting brokers, shippers, and legitimate carriers from financial and reputational harm.

For load boards, carriers may access digital load boards by providing an identifier and authenticating via voice. Only authorized voices associated with the identifier may be permitted to claim loads. Brokers may verify the identity of carriers calling in by matching the caller's voice to voice data associated with the provided identifier. Prior to releasing payments for completed shipments, carriers may be authenticated to ensure payments are issued to authorized parties. During audits or regulatory interactions, carriers may authenticate themselves using voice and identifiers, simplifying verification for brokers and authorities.

Multiple voice models or voice representations may be associated with the same identifier, allowing team-based or multi-user authentication under a single MC number or DOT number.

Audio preprocessing and data augmentation techniques may be used to improve robustness in real-world conditions.

For an initial enrollment effort, the system may start with high-value carriers and gradually onboard additional carriers, focusing on those handling sensitive or high-value shipments.

For load brokers, carriers can be registered with their DOT number and voice samples. One or more voice models associated with the carrier are trained in association with their DOT number. Carrier calls the broker: “My DOT number is 123456. I'm confirming the pickup for load 7890”. The broker's system: verifies the DOT number; matches the voice command to one or more voice models associated with that DOT number; and grants access to shipment details if authenticated. A shipment update can be from a carrier “Yes, my DOT 123456. The load has been delivered.” The system authenticates the voice and updates the shipment status. For shipment update, carrier: “My DOT 123456. I'm confirming payment for load 7890.” The system uses VoiceID as a security signal for the carrier before releasing payment.

For brokers, enhanced security can reduce unauthorized use of identifiers. Accountability by voice-linked interactions can reduce disputes. Efficiency can result in faster identity verification during operations.

For carriers, trust can protect carrier identifiers from misuse. Also, verification can be simplified during audits and communications.

For logistics industry, a higher standard of security and trust in carrier identity verification can be established. Fraud, theft, and operational inefficiencies can be reduced.

Considerations for implementing and refining the two-factor authentication (2FA) system combining passphrase and voice recognition include security enhancements such as dynamic passphrases, replay attack preventions, and multi-layer biometrics

System design considerations include real-time processing and user privacy. The system can optimize the speech-to-text and voice authentication models to process data in real-time, ensuring a seamless user experience. Further, the system can securely store user data, ensuring compliance with privacy regulations like GDPR, HIPAA, or CCPA. Encryption can be used for voice data and passphrase logs.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, a computer network may be any group of computing systems, computing devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

1. A system comprising:
a voice identification module configured to:
receive voice data associated with a user;
receive user input that indicates an identifier of the user;
analyze the voice data of the user to generate at least one confidence metric indicative of a consistency of the voice data of the user with stored voice data of an identified user;
determine whether the at least confidence metric meets one or more criterion for authenticating a user's voice; and
implement an action associated with authenticating the user associated with the received voice data and the identifier of the user in response to a determination that the at least confidence metric meets one or more criterion for authenticating a user's voice.

2. The system of claim 1, wherein the voice data includes voice data of a passphrase input by the user.

3. The system of claim 1, wherein the voice identification module is configured to:
communicate, to a computing device of the user, a passphrase for prompting input of voice by the user;
receive voice data corresponding to the user speaking the passphrase for input;
apply speech-to-text processing to determine that the spoken passphrase in the received voice data matches the passphrase;
analyze the spoken passphrase to determine that the spoken passphrase matches the user's voice; and
authenticate the user based on the determination that the spoken passphrase in the received voice data matches the passphrase and the determination that the spoken passphrase matches the user's voice.

4. The system of claim 1, wherein the voice identification module is configured to receive the audio data during an active communication session.

5. The system of claim 1, wherein the voice identification module is configured to preprocess the voice data prior to analysis.

6. The system of claim 1, wherein the voice identification module is configured to one of apply noise reduction to the audio data, and/or convert the audio data into one or more feature representations for subsequent analysis.

7. The system of claim 1, wherein the voice identification module is configured to:
receive user input that specifies an identifier of the user; and
select one or more voice models associated with the specified identifier for evaluation.

8. The system of claim 1, wherein the voice identification module is configured to:
initiate a communication session with a computing device of the user;
receive, from the computing device operated by the user, identifying information input by the user;
communicate, to the computing device of the user, a passphrase for prompting input of voice by the user;
receive, from the computing device of the user, voice data corresponding to the user speaking the passphrase for input;
analyze the spoken passphrase to determine that the spoken passphrase matches the user's voice and that the spoken passphrase in the received voice data matches the passphrase; and
authenticate the user based on the determination that the spoken passphrase in the received voice data matches the passphrase and the determination that the spoken passphrase matches the user's voice.

9. The system of claim 8, wherein the voice identification module is configured to:
set a time period for providing the spoken passphrase; and
authenticate the user based on whether the spoken passphrase is received within the time period.

10. The system of claim 1, wherein the voice identification module is configured to generate the at least one confidence metric by use of a convolutional autoencoder process, a long short-term memory process, and/or a time delay neural network.

11. The system of claim 1, wherein the voice identification module is configured to:
apply a spectrogram of the voice data to identify unique features of the user's voice; and
determine the at least one confidence metric based on the identified unique features of the user's voice.

12. The system of claim 1, wherein the voice identification module is configured to communicate with a computing device of the user via an SMS-based communication modality, a chat-based communication modality, and/or an email-based communication modality.

13. A system comprising:
a voice identification module configured to:
initiate a communication session with a user via the user's computing device;
receive, from the user's computing device, an identifier of the user;
determine that the identifier of the user is verified;
in response to the determination that the identifier of the user is verified, send a passphrase to the user's computing device for prompting the user to speak the passphrase;
receive, from the user's computing device, voice data corresponding to the user speaking the passphrase for input;
analyze the spoken passphrase to determine that the spoken passphrase matches the user's voice and that the spoken passphrase in the received voice data matches the sent passphrase; and
authenticate the user based on the determination that the spoken passphrase in the received voice data matches the passphrase, the determination that the spoken passphrase matches the user's voice, and that the spoken passphrase is received within a predetermined time period subsequent to sending the passphrase to the user's computing device.

14. The system of claim 13, wherein the communication session is a voice-based communication session.

15. The system of claim 13, wherein the identifier of the user includes a username, a user identifying number, and/or a telephone number.

16. The system of claim 13, wherein the initiated communication session is via a first communication modality, and
wherein the voice identification module is configured to send the passphrase to the user's computing device via a second communication modality different than the first communication modality.

17. The system of claim 16, wherein the second communication modality is an SMS-based communication modality, a chat-based communication modality, and/or an email-based communication modality.

18. The system of claim 13, wherein the voice identification module is configured to determine that the spoken passphrase matches the user's voice by use of a convolutional autoencoder process, a long short term memory process, and/or a time delay neural network.

19. The system of claim 13, wherein the time period is at least about 15 seconds.

20. The system of claim 13, wherein the voice identification module is configured to utilize a virtual agent and/or a virtual avatar for implementing the communication session.

21. The system of claim 13, wherein the voice identification module is configured to utilize a virtual avatar based on a virtual agent, an avatar visual component, and an avatar audio component.

22. A computer-implemented method comprising:
receiving voice data associated with a user;
receiving user input that indicates an identifier of the user;
analyzing the voice data of the user to generate at least one confidence metric indicative of a consistency of the voice data of the user with stored voice data of an identified user;
determining whether the at least confidence metric meets one or more criterion for authenticating a user's voice; and
implementing an action associated with authenticating the user associated with the received voice data and the identifier of the user in response to a determination that the at least confidence metric meets one or more criterion for authenticating a user's voice.

23. The computer-implemented method of claim 22, wherein the voice data includes voice data of a passphrase input by the user.

24. The computer-implemented method of claim 22, further comprising:
communicating, to a computing device of the user, a passphrase for prompting input of voice by the user;
receiving voice data corresponding to the user speaking the passphrase for input;
applying speech-to-text processing to determine that the spoken passphrase in the received voice data matches the passphrase;
analyzing the spoken passphrase to determine that the spoken passphrase matches the user's voice; and
authenticating the user based on the determination that the spoken passphrase in the received voice data matches the passphrase and the determination that the spoken passphrase matches the user's voice.

25. The computer-implemented method of claim 22, further comprising receiving the audio data during an active communication session.

26. The computer-implemented method of claim 22, further comprising preprocessing the voice data prior to analysis.

27. The computer-implemented method of claim 22, further comprising one of applying noise reduction to the audio data, and/or converting the audio data into one or more feature representations for subsequent analysis.

28. The computer-implemented method of claim 22, further comprising:
receiving user input that specifies an identifier of the user; and
selecting one or more voice models associated with the specified identifier for evaluation.

29. The computer-implemented method of claim 22, further comprising:
initiating a communication session with a computing device of the user;
receiving, from the computing device operated by the user, identifying information input by the user;
communicating, to the computing device of the user, a passphrase for prompting input of voice by the user;
receiving, from the computing device of the user, voice data corresponding to the user speaking the passphrase for input;
analyzing the spoken passphrase to determine that the spoken passphrase matches the user's voice and that the spoken passphrase in the received voice data matches the passphrase; and
authenticating the user based on the determination that the spoken passphrase in the received voice data matches the passphrase and the determination that the spoken passphrase matches the user's voice.

30. A computer-implemented method comprising:
initiating a communication session with a user via the user's computing device;
receiving, from the user's computing device, an identifier of the user;
determining that the identifier of the user is verified;
sending a passphrase to the user's computing device for prompting the user to speak the passphrase in response to the determination that the identifier of the user is verified;
receiving, from the user's computing device, voice data corresponding to the user speaking the passphrase for input;
analyzing the spoken passphrase to determine that the spoken passphrase matches the user's voice and that the spoken passphrase in the received voice data matches the sent passphrase; and
authenticating the user based on the determination that the spoken passphrase in the received voice data matches the passphrase, the determination that the spoken passphrase matches the user's voice, and that the spoken passphrase is received within a predetermined time period subsequent to sending the passphrase to the user's computing device.
